(19) United States
(12) Patent Application Publication
(10) Pub. No.: US 2009/0277017 A1
(43) Pub. Date: Nov. 12, 2009

(54) HEDGE TRIMMER

(75) Inventors: Mickey Reiss, New York, NY (US); Isaac Secemski, Teaneck, NJ (US)

Correspondence Address: AMSTER, ROTHSTEIN & EBENSTEIN LLP, 90 PARK AVENUE, NEW YORK, NY, 10016, US

(73) Assignee: ABRAHAM JOSHUA HESCHEL SCHOOL, New York, NY (US)

(21) Appl. No.: 12/116,432

(22) Filed: May 7, 2008

(51) Int. Cl. A01G 3/053; F16L 57/00

(52) U.S. Cl. 30/210; 248/51

(57) ABSTRACT

A hedge trimmer comprising: a chassis; a set of blades protruding from one end of the chassis; a cord extending from a second end of the chassis; and a rigid cord protector secured to a portion of the cord at end of the cord attached to the second end of the chassis.

### FIELD OF INVENTION

The present invention generally relates to hedge trimmers. More particularly, the present invention relates to protecting the electric cord of a hedge trimmer from being damaged during operation.

### NO GOVERNMENT LICENSE RIGHTS

No federal government funding was used to developed the present invention. Rather, the present invention was conceived as part of a high school class project at the Abraham Joshua Heschel School in New York City, N.Y.

### BACKGROUND OF THE INVENTION

Electric powered hedge trimmers very conveniently trim hedges and similar shrubbery. These hedge trimmers can be powered by an internal source such as a battery or gas. They can also be powered by an external electric source by use of a long heavy duty electric cord that connects the hedge trimmer to the electric source. These hedge trimmers have flexibility and can operate at a significant distance from the electric power source. However, there has been a long standing problem with using hedge trimmers powered by an external electric source. During operation of this type of hedge trimmer, it is common for the oscillating teeth of the hedge trimmer to come in contact with the electric cord, damaging and even severing the cord. Not only is it expensive and inconvenient to replace such a heavy duty cord, but there is also a danger posed from any wires exposed when the cord was damaged. This is especially true when those exposed wires come in contact with the metal teeth of the hedge trimmer.

### SUMMARY OF THE INVENTION

According to an exemplary embodiment of the present invention, a hedge trimmer is disclosed comprising: a chassis; a set of blades protruding from one end of the chassis; a cord extending from a second end of the chassis; and a rigid cord protector secured to a portion of the cord at the end of the cord attached to the second end of the chassis.

In at least one embodiment, the rigid cord protector is at least one foot in length.

In at least one embodiment, the rigid cord protector is at least two feet in length.

In at least one embodiment, the rigid cord protector removably covers the portion of the cord.

In at least one embodiment, the rigid cord protector is attached to the cord near the second end of the chassis at a distance less than a length of the chassis.

In at least one embodiment, the rigid cord protector is attached to the cord near the second end of the chassis at a distance greater than one inch from the chassis.

In at least one embodiment, the rigid cord protector is attached to the cord near the second end of the chassis at a distance of about two inches from the chassis.

In at least one embodiment, the rigid cord protector is comprised of a plurality of clips and a rigid rod.

In at least one embodiment, the rigid cord protector is substantially immobile in relation to the cord.

In at least one embodiment, the rigid cord protector is not more than four feet in length.

In at least one embodiment, the rigid cord protector is three feet in length.

### BRIEF DESCRIPTION OF THE DRAWINGS

The above and related objects, features and advantages of the present invention will be more fully understood by reference to the following, detailed description of an embodiment of the present invention when taken in conjunction with the accompanying figures, wherein:

FIG. 1A is a schematic top view of an embodiment of the invention.

FIG. 1B is a schematic side view of the embodiment of the invention shown in FIG. 1A.

FIG. 2 is a schematic top view of another embodiment of the invention.

### DETAILED DESCRIPTION OF THE PRESENT INVENTION

The following is a description of various embodiments of the present invention, although the intention is not to narrowly limit the invention to the exact specifics described herein but to cover systems that lie within the spirit and scope of the invention.

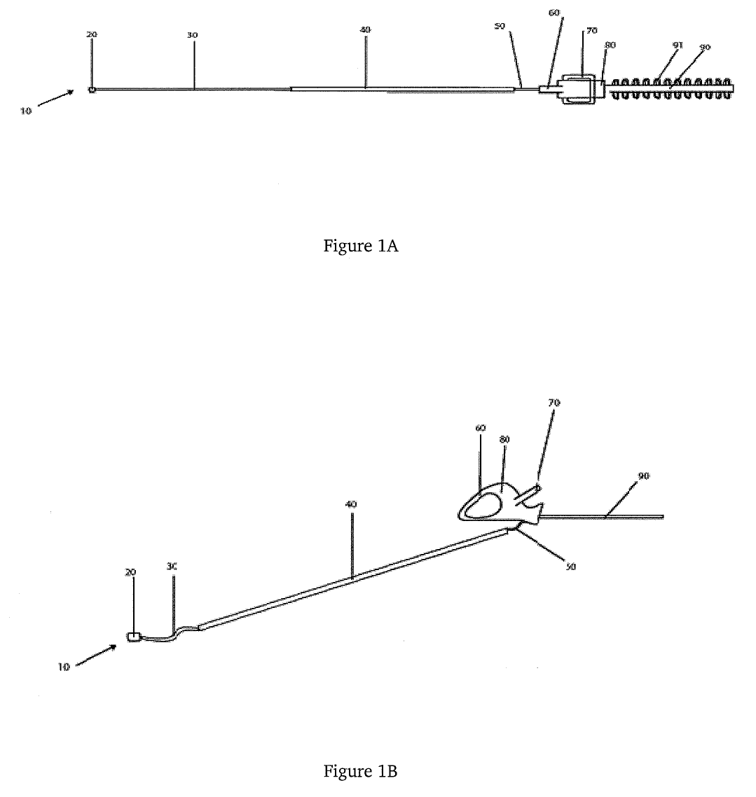

The present invention relates to a hedge trimmer that protects its electric cord from being damaged or severed by the teeth of the hedge trimmer during operation. As shown in FIG. 1A, the hedge trimmer (10) of the present invention comprises a chassis (80), a set of blades (90) protruding from one end of the chassis (80), an electric cord (30, 50) extending from a second end of the chassis (80), and a rigid cord protector (40) secured to a portion of the electric cord at an end of the cord attached to the second end of the chassis (80). The set of blades (90) has oscillating teeth (91) which protrude from the blades. The hedge trimmer (10) of the present invention maintains that part of the electric cord closest to the hedge trimmer teeth (91) in a rigid, linear position. The hedge trimmer of the present invention prevents or inhibits the teeth (91) from interacting with the cord (30, 50). Generally, this interaction is most likely to occur on the portions of the cord (50) that is closest to the chassis (80) and is not lying on the ground.

The present invention maintains the portion of the cord (50) that is closest to the chassis (80) in a rigid position to prevent the cord from inadvertently contacting the teeth (91) of the hedge trimmer (10). During the to and fro swinging of the hedge trimmer, it is unlikely that the hedge trimmer of the present invention will be bent back so far as to result in the oscillating teeth (91) coming into contact with the rigid portion of the cord. In addition, because the portion of the cord (30) that is beyond the rigid section is too far from the arc of operation of the hedge trimmer, that portion (30) is not in danger of being caught between the teeth of the hedge trimmer. In particular, that part of the cord (30) that lies beyond the rigid portion is likely to trail along the ground and therefore not be in danger of damage from the teeth. There is no impediment to using the hedge trimmer with the rigid cord protector (40) of the current invention. This is because the rigidity of the cord does not significantly affect the mobility of the hedge trimmer. The rigidity of the cord also has the advantage of preventing the cord from becoming entangled in a hedge during the backward and forward sweep of the hedge trimmer when cutting the hedge.

Previous methods of preventing hedge trimmers from damaging or cutting electrical extension cords have primarily been based on adding a covering to the cord. This increases the diameter of the electrical cord such that it will no longer fit between the teeth of the hedge trimmer. This type of complexity is avoided in the present invention.

The rigid cord protector (40) of the present invention can be attached to the cord in various ways. For example, in one embodiment of the present invention as shown in FIGS. 1A and 1B the rigid cord protector can be made of any suitable material as long as it is lightweight and maintains linear rigidity. The rigid cord protector (40) that envelopes the electric cord is at least one foot in length and not greater than four feet in length. The cord protector (40) is made of a rigid, lightweight material that maintains the cord in a rigid linear state. This ensures that the cord cannot bend back on itself and so be caught within the teeth of the hedge trimmer.

In an embodiment of the present invention, a part of the cord is maintained in a rigid linear position but also has flexibility relative to the chassis (80) and blade assembly (90) of the hedge trimmer (10) and is allowed to bend out of the plane of the chassis and blade assembly. To allow this, a gap (60) is provided between the chassis of the hedge trimmer (80) and that part of the cord protector closest to the chassis, in which gap the cord remains flexible (50). In an embodiment of the present invention, the length of this gap (60) where the electric cord is not covered by the cord protector and is not maintained in a rigid linear position should be approximately two inches. This length is sufficient to allow the necessary flexibility, but not to expose the unprotected cord to the teeth of the hedge trimmer. While the length of this gap can vary, the rigid cord protector (40) should be attached to the chassis (80) at a distance that is greater than one inch from the chassis but less than the length of the chassis.

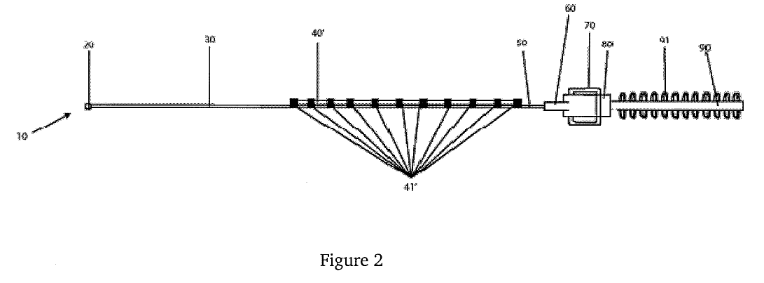

FIG. 2 represents another embodiment of the present invention.

FIG. 2 is a schematic top view of a hedge trimmer (10′) with an electric cord (30, 50), the rigidity of the cord being maintained by a rigid rod (40′) that is attached to the outside of the electric cord by means of a plurality of clips (41′). Once the rigid rod (40′) is attached to the electric cord, there should be no relative movement between the rigid rod and the cord.

As an embodiment, the length of the rigid rod should be no less than one foot and no more than four feet in length. Preferably, the rigid rod should be no more than three feet in length. In addition, the region of the electric cord closest to the chassis (80) and blade assembly (90) of the hedge trimmer should not be maintained in a rigid linear position to allow the rigid part of the cord some movement. The length of free cord (50) should be about two inches in length. Any suitable material of composition of the rigid rod can be used that remains linearly rigid under typical conditions that typically exist during hedge trimming, and light enough to avoid impeding movement during hedge trimming. In addition, clips as are well known in the art can be used to maintain the flexible electric cord in a linear rigid position on the side of the rigid rod.

In another embodiment of the present invention, the rigid cord protector has a slit along its length that allows it to easily slip over the cord.

Now that various embodiments of the present invention have been shown and described in detail, various modifications and improvements thereon will become readily apparent to those skilled in the art. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed:

1. A hedge trimmer comprising:
a chassis;
a set of blades protruding from one end of the chassis;
a cord extending from a second end of the chassis; and
a rigid cord protector secured to a portion of the cord at end of the cord attached to the second end of the chassis.

2. The hedge trimmer of claim 1 wherein the rigid cord protector is at least one foot in length.

3. The hedge trimmer of claim 1 wherein the rigid cord protector is at least two feet in length.

4. The hedge trimmer of claim 1 wherein the rigid cord protector removably covers the portion of the cord.

5. The hedge trimmer of claim 1 wherein the rigid cord protector is attached to the cord near the second end of the chassis at a distance less than a length of the chassis.

6. The hedge trimmer of claim 5 wherein the rigid cord protector is attached to the cord near the second end of the chassis at a distance greater than one inch from the chassis.

7. The hedge trimmer of claim 1 wherein the rigid cord protector is attached to the cord near the second end of the chassis at a distance of about two inches from the chassis.

8. The hedge trimmer of claim 1 wherein the rigid cord protector is comprised of a plurality of clips and a rigid rod.

9. The hedge trimmer of claim 1, wherein the rigid cord protector is substantially immobile in relation to the cord.

10. The hedge trimmer of claim 2, wherein the rigid cord protector is not more than four feet in length.

11. The hedge trimmer of claim 2, wherein the rigid cord protector is three feet in length.
